(19) United States
(12) Patent Application Publication
(10) Pub. No.: US 2015/0045495 A1
(43) Pub. Date: Feb. 12, 2015

(54) PIGMENT COMPOSITION, METHOD FOR PRODUCING THE SAME AND AQUEOUS INKJET INK

(71) Applicants: Yasuyo Hirose, Sakura-shi (JP); Jouji Kawamura, Sakura-shi (JP); Takahito Ikuma, Sakura-shi (JP); Hiroshi Kinoshita, Sakura-shi (JP)

(72) Inventors: Yasuyo Hirose, Sakura-shi (JP); Jouji Kawamura, Sakura-shi (JP); Takahito Ikuma, Sakura-shi (JP); Hiroshi Kinoshita, Sakura-shi (JP)

(73) Assignee: DIC CORPORATION, Tokyo (JP)

(21) Appl. No.: 14/343,360

(22) PCT Filed: Sep. 6, 2012
(86) PCT No.: PCT/JP2012/072713

§ 371 Date: Aug. 19, 2014

(30) Foreign Application Priority Data
Sep. 7, 2011 (JP) 2011-194918

(51) Int. Cl. C09D 11/322; C09D 11/107; C09D 125/14

(52) U.S. Cl. CPC C09D 11/322; C09D 125/14; C09D 11/107
USPC 524/522

(57) ABSTRACT

There is provided a method for producing a pigment composition which contains a polymer-treated pigment (D) containing an azo lake pigment (A) and an aqueous polymer (C) precipitated with a polyvalent metal salt (B) and also contains a polymer (F) obtained by polymerizing a polymerizable unsaturated monomer (E) in the presence of the polymer-treated pigment (D). The method includes: synthesizing an azo dye by coupling a coupler component with a diazo component obtained by diazotizing an aromatic amine; and preparing the polymer-treated pigment (D). The method also includes producing the polymer (F) by polymerizing the polymerizable unsaturated monomer (E) in the presence of the polymer-treated pigment (D) to coat the polymer-treated pigment (D) with the polymer (F).

### TECHNICAL FIELD

The present invention relates to a pigment composition which has low dispersion viscosity and excellent dispersion stability even though fine pigment particles are used, a method for producing the same, and an aqueous inkjet ink containing the pigment composition.

### BACKGROUND ART

Azo lake pigments obtained by lacing an azo compound, obtained by coupling a coupler component with a diazo component obtained by diazotizing an aromatic amine, with metal are widely used in colorants for ink, paint, and resin. The azo lake pigments are excellent in color developability and therefore have been frequently used in planographic ink and gravure ink applications. In recent years, pigments exhibiting high color developability have been required in aqueous ink applications, particularly in the field of aqueous inkjet inks. The azo lake pigments have color developability matched to such requirements.

However, an azo lake pigment has a salt structure containing metal ions in its molecule and therefore is problematic in that the azo lake pigment has poor water resistance and also has poorer dispersibility and storage stability in aqueous media as compared to other pigments. In addition, an aqueous ink containing a pigment generally has problems with poor dispersion stability and ease of flocculation because the pigment is insoluble in media. Furthermore, in the case of aqueous inkjet ink applications, even a pigment ink needs to contain a pigment made as fine as possible in order to achieve enhanced color developability and transparency and needs to keep the dispersion state thereof stable. However, the refining of the pigment causes the crush of primary particles of the pigment and is likely to cause the re-aggregation thereof because surface energy is increased and cohesive energy is increased, resulting in an adverse effect that the storage stability of a refined pigment dispersion is impaired.

A pigment composition containing a water-soluble acrylic polymer and a monoazo pigment laced with a coupler component in the presence of a water-soluble acrylic polymer is disclosed for gravure ink applications (refer to Patent Literature 1). However, though certain storage stability is obtained by a method disclosed in Patent Literature 1, viscosity increases significantly in the case of storage in an aqueous medium; hence, storage stability is not sufficient.

### CITATION LIST

### Patent Literature

PTL 1: Japanese Unexamined Patent Application Publication No. 2004-67893

### SUMMARY OF INVENTION

### Technical Problem

The present invention provides a pigment composition which has low dispersion viscosity and excellent dispersion stability even though fine pigment particles are used and an aqueous inkjet ink containing the pigment composition.

### Solution to Problem

That is, the present invention relates to a pigment composition which contains a polymer-treated pigment (D) containing an azo lake pigment (A) and an aqueous polymer (C) precipitated with a polyvalent metal salt (B) and also contains a polymer (F) obtained by polymerizing a polymerizable unsaturated monomer (E) in the presence of the polymer-treated pigment (D).

Furthermore, the present invention relates to a method for producing a pigment composition. The method includes a step of synthesizing an azo dye by coupling a coupler component with a diazo component obtained by diazotizing an aromatic amine, a step of preparing a polymer-treated pigment (D) containing an azo lake pigment (A) and an aqueous polymer (C) precipitated with a polyvalent metal salt (B) in such a way that the aqueous polymer (C) precipitated with the polyvalent metal salt (B) is added to the azo dye and the azo dye and the aqueous polymer (C) precipitated with the polyvalent metal salt (B) are co-precipitated with the polyvalent metal salt (B), and a step of producing a polymer (F) by polymerizing a polymerizable unsaturated monomer (E) in the presence of the polymer-treated pigment (D) to coat the polymer-treated pigment (D) with the polymer (F).

Furthermore, the present invention relates to a method for producing a pigment composition. This method includes a step of synthesizing an azo dye by coupling a coupler component with a diazo component obtained by diazotizing an aromatic amine, a step of preparing a polymer-treated pigment (D) containing an azo lake pigment (A) and an aqueous polymer (C) precipitated with a polyvalent metal salt (B) in such a way that the aqueous polymer (C) precipitated with the polyvalent metal salt (B) is added to the azo dye and the azo dye and the aqueous polymer (C) precipitated with the polyvalent metal salt (B) are co-precipitated with a polyvalent metal salt (b-1), a step of producing a polymer (F) by polymerizing a polymerizable unsaturated monomer (E) in the presence of the polymer-treated pigment (D) to coat the polymer-treated pigment (D) with the polymer (F), and a step of partially or entirely replacing the polyvalent metal salt (b-1) in the polymer-treated pigment (D) with a polyvalent metal salt (b-2) different from the polyvalent metal salt (b-1) by subjecting the polyvalent metal salt (b-2) to reaction.

Furthermore, the present invention relates to an aqueous inkjet ink containing the pigment composition.

### Advantageous Effects of Invention

The present invention provides a pigment composition which contains a polymer-treated pigment (D) containing an azo lake pigment (A) and an aqueous polymer (C) precipitated with a polyvalent metal salt (B) and also contains a polymer (F) obtained by polymerizing a polymerizable unsaturated monomer (E) in the presence of the polymer-treated pigment (D), whereby an aqueous inkjet ink which has low dispersion viscosity and excellent dispersion stability even though fine pigment particles are used can be obtained.

Furthermore, according to the present invention, a pigment composition which has low dispersion viscosity, excellent dispersion stability, and little change in hue even though fine pigment particles are used can be obtained through a step of synthesizing an azo dye by coupling a coupler component with a diazo component obtained by diazotizing an aromatic amine, a step of preparing a polymer-treated pigment (D) containing an azo lake pigment (A) and an aqueous polymer (C) precipitated with a polyvalent metal salt (B) in such a way that the aqueous polymer (C) precipitated with the polyvalent metal salt (B) is added to the azo dye and the azo dye and the aqueous polymer (C) precipitated with the polyvalent metal salt (B) are co-precipitated with a polyvalent metal salt (b-1), a step of producing a polymer (F) by polymerizing a polymerizable unsaturated monomer (E) in the presence of the polymer-treated pigment (D) to coat the polymer-treated pigment (D) with the polymer (F), and a step of partially or entirely replacing the polyvalent metal salt (b-1) in the polymer-treated pigment (D) with a polyvalent metal salt (b-2) different from the polyvalent metal salt (b-1) by subjecting the polyvalent metal salt (b-2) to reaction.

### DESCRIPTION OF EMBODIMENTS

### Azo Lake Pigment (A)

An azo lake pigment (A) is a pigment obtained in such a way that an azo dye is synthesized by coupling a coupler component with a diazo component obtained by diazotizing an aromatic amine and is laced with a polyvalent metal salt.

In the present invention, a method for producing the azo dye may be a well-known or common method.

Examples of the diazo component obtained by diazotizing the aromatic amine include those obtained by diazotizing 4-aminotoluene-3-sulfonic acid (p-toluidine-m-sulfonic acid: 4B acid), 4-amino-2-chlorotoluene-5-sulfonic acid (2B acid), 3-amino-6-chlorotoluene-4-sulfonic acid (C acid), 2-aminonaphthalene-1-sulfonic acid (Tobias acid), and the like.

Well-known or common phenols and naphthols can be used as the coupler component. Examples of the coupler component include 2-hydroxy-3-naphthoic acid, β-naphthol, and acetoacetanilide. Alternatively, the coupler component may be a derivative of those described above or a compound substituted with, for example, a lower alkyl group, an alkoxy group, or a halogen atom.

The azo dye can be produced by a conventionally known method for producing a monoazo lake pigment. That is, an aromatic amine containing a soluble group is diazotized in accordance with common practice, the coupler component is prepared into a grounding solution in accordance with common practice, and they may be coupled in accordance with common practice.

The azo lake pigment (A) can be obtained in such a way that the obtained azo dye is laced with the polyvalent metal salt (B) or the diazo component and the coupler component are subjected to reaction and are simultaneously laced with the polyvalent metal salt (B). The polyvalent metal salt may be well-known or common one or a salt containing, for example, a polyvalent metal such as a divalent, trivalent, or tetravalent metal. Examples of the polyvalent metal salt include Ca salts, Ba salts, Sr salts, Al salts, and Zn salts. Particular examples of the polyvalent metal salt include calcium chloride, barium chloride, strontium chloride, aluminium chloride, zinc chloride, calcium sulfate, barium sulfate, and strontium sulfate. The use of a combination of a Ca salt and an Sr salt is most preferred in consideration of hue.

[Polymer-Treated Pigment (D)]

In the present invention, the polymer-treated pigment (D) is one obtained by coating the azo lake pigment (A) with the aqueous polymer (C) precipitated with the polyvalent metal salt (B). Since the azo lake pigment (A) is coated with the aqueous polymer (C), the water resistance of the pigment is increased. Since the aqueous polymer (C) is an aqueous polymer precipitated with the polyvalent metal salt (B) used to lace the azo dye, the polymer-treated pigment (D), in which the pigment surface is uniformly coated with the aqueous polymer, can be obtained in such a way that the aqueous polymer (C) is precipitated simultaneously with the lacing of the pigment.

Examples of the aqueous polymer (C) precipitated with the polyvalent metal salt (B) include polymers containing a plurality of acid groups per molecule, monovalent metal salts of the polymers, ammonium salts of the polymers, and amine salts of the polymers. Particular examples of the aqueous polymer (C) include poly(meth)acrylic acid, (meth)acrylate-(meth)acrylic acid copolymers, styrene-(meth)acrylic acid copolymers, isobutylene-maleic acid copolymers, styrene-maleic acid copolymers, polymaleic acid, sodium salts of these compounds, potassium salts of these compounds, and ammonium salts of these compounds.

These aqueous polymers may be used alone or in combination. The aqueous polymer used herein is not particularly limited in form and may be a random copolymer, a block copolymer, or the like.

The amount of the aqueous polymer used is preferably 0.1 parts to 100 parts and more preferably 10 parts to 40 parts per 100 parts of the coupler component in terms of a solid. The amount of the aqueous polymer used is preferably within the above range because particularly excellent dispersion stability is maintained in an aqueous medium.

[Pigment Composition]

A pigment composition according to the present invention is characterized in that the polymer (F) is obtained by polymerizing the polymerizable unsaturated monomer (E) in the presence of the polymer-treated pigment (D). Sufficient storage stability is not achieved using the polymer-treated pigment (D) alone but high storage stability can be achieved in such a way that the polymerizable unsaturated monomer (E) is polymerized and the polymer-treated pigment (D) is coated with the polymer (F).

In the case where the polymer (F) obtained by subjecting the polymerizable unsaturated monomer (E) to reaction is prepared separately from the polymer-treated pigment (D) and is then mixed with the polymer-treated pigment (D), the surface of the polymer-treated pigment (D) is unlikely to be uniformly coated with the polymer (F) and it is difficult to achieve storage stability as expected. However, in the case of polymerizing the polymerizable unsaturated monomer (E) in the presence of the polymer-treated pigment (D), the polymer (F) is uniformly formed on the surface of the polymer-treated pigment (D) and therefore it is predicted that the surface thereof of can be covered without any space. Therefore, the obtained pigment composition is capable of having excellent storage stability.

[Polymerizable Unsaturated Monomer (E)]

In the present invention, examples of the polymerizable unsaturated monomer (E) include so-called reactive polar group (functional group)-free vinylic monomers such as olefins including methyl (meth)acrylate, ethyl (meth)acrylate, n-propyl (meth)acrylate, i-propyl (meth)acrylate, (meth)acrylonitrile, styrene, ethylvinylbenzene, vinyl acetate, vinyl chloride, vinylidene chloride, vinyl fluoride, and vinylidene fluoride and polycyclic monomers including isobornyl (meth)acrylate, dicyclopentenyl (meth)acrylate, dicyclopentenyloxyethyl (meth)acrylate, and dicyclopentanyl (meth)acrylate; amide bond-containing vinylic monomers such as (meth)acrylamide, dimethyl (meth)acrylamide, N-t-butyl (meth)acrylamide, N-octyl (meth)acrylamide, diacetone acrylamide, dimethylaminopropyl acrylamide, and alkoxylated N-methylol (meth) acrylamide; phosphorus atom-containing vinylic monomers such as dialkyl [(meth)acryloyloxyalkyl]phosphates, (meth)acryloyloxyalkyl acid phosphates, dialkyl [(meth)acryloyloxyalkyl]phosphites, (meth)acryloyloxyalkyl acid phosphites, ester compounds of phosphoric acid, phosphorus acid, or acidic esters and epoxy group-containing vinylic monomers including alkylene oxide adducts of the (meth)acryloyloxyalkyl acid phosphates and acid phosphites, glycidyl (meth)acrylate, and methylglycidyl (meth)acrylate, and 3-chloro-2-acid phosphoxypropyl (meth)acrylate; hydroxyl group-containing polymerizable unsaturated monomers such as hydroxyalkyl esters of polymerizable unsaturated carboxylic acids that include 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, 3-chloro-2-hydroxypropyl (meth)acrylate, di-2-hydroxyethyl fumarate, mono-2-hydroxyethyl monobutyl fumarate, polypropylene glycol, polyethylene glycol mono(meth)acrylate, and “Placcel FM, FA Monomer” (a caprolactone-added monomer produce by Daicel Chemical Industries Ltd.), adducts of ε-caprolactone and these esters, unsaturated mono- and dicarboxylic acids including (meth)acrylic acid, crotonic acid, maleic acid, fumaric acid, itaconic acid, and citraconic acid, adducts of polymerizable unsaturated carboxylic acids including monoesters of these dicarboxylic acids and monovalent alcohols or various unsaturated carboxylic acids including adducts of the polymerizable unsaturated carboxylic acid hydroxyalkyl esters and anhydrides of polycarboxylic acids including maleic acid, succinic acid, phthalic acid, hexahydrophthalic acid, tetrahydrophthalic acid, benzenetricarboxylic acid, benzenetetracarboxylic acid, “himic acid”, tetrachlorophthalic acid, and dodecenyl succinic acid and monoglycidyl esters of monovalent carboxylic acids that include “Cardura E”, coconut fatty acid glycidyl ester, and octylic acid glycidyl ester or monoepoxy compounds including butyl glycidyl ether, ethylene oxide, and propylene oxide, adducts of ε-caprolactone and these compounds, and hydroxyvinyl ether; dialkylaminoalkyl (meth)acrylates such as dimethylaminoethyl (meth)acrylate and diethylaminoethyl (meth)acrylate; epoxy group-containing polymerizable unsaturated monomers such as glycidyl (meth)acrylate, (β-methyl) glycidyl (meth)acrylate, (meth)allyl glycidyl ether, and epoxy group-containing polymerizable compounds obtained by the equimolar addition of various polyepoxy compounds, such as “EPICLON 200”, “EPICLON 400”, “EPICLON 441”, “EPICLON 850”, “EPICLON 1050” (epoxy resins produced by DIC Corporation), “Epicoat 828”, “Epicoat 1001”, “Epicoat 1004” (epoxy resins produced by Japan Epoxy Resins Co., Ltd.), “Araldite 6071”, “Araldite 6084” (epoxy resins produced by Ciba-Geigy Corporation of Switzerland), “Chissonox 221” (an epoxy compound produced by Chisso Corporation), and “Denacol EX-611” (an epoxy compound produced by Nagase Chemicals, Ltd.), containing at least two epoxy groups per molecule to polymerizable unsaturated carboxylic acids or various unsaturated carboxylic acids including equimolar adducts of the polycarboxylic acid anhydrides and hydroxyl group-containing vinyl polymers including mono-2-(meth)acryloyloxymonoethyl phthalate; isocyanate group-containing α,β-ethylenic unsaturated monomers such as 2-hydroxyethyl (meth)acrylate-hexamethylene diisocyanate equimolar adducts and monomers, including isocyanatothyl (meth)acrylate, containing an isocyanate group and a vinyl group; alkoxysilyl group-containing polymerizable unsaturated monomers such as vinylethoxysilane, α-methacryloxypropyl trimethoxysilane, trimethylsiloxyethyl (meth)acrylate, and silicone monomers including “KR-215” and “X-22-5002” (products of Shin-Etsu Chemical Co., Ltd.); and carboxyl group-containing α,β-ethylenic unsaturated monomers such as unsaturated mono- and dicarboxylic acids including (meth)acrylic acid, crotonic acid, maleic acid, fumaric acid, itaconic acid, and citraconic acid and adducts of α,β-ethylenic unsaturated carboxylic acids including monoesters of these dicarboxylic acids and monovalent alcohols or polymerizable unsaturated carboxylic acid hydroalkyl esters including 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, 3-chloro-2-hydroxypropyl (meth)acrylate, di-2-hydroxyethyl fumarate, mono-2-hydroxyethyl monobutyl fumarate, and polyethylene glycol mono(meth)acrylate and anhydrides of polycarboxylic acids including maleic acid, succinic acid, phthalic acid, hexahydrophthalic acid, tetrahydrophthalic acid, benzenetricarboxylic acid, benzenetetracarboxylic acid, “himic acid”, tetrachlorophthalic acid, and dodecenyl succinic acid. In particular, polymerizable unsaturated monomers, such as ethylvinylbenzene and dicyclopentanyl (meth)acrylate, having high hydrophobicity are preferably used.

In addition, in order to prevent the polymer (F) from being eluted from the polymer-treated pigment (D), the polymer (F) is preferably cross-linked. Examples of a polyfunctional polymerizable unsaturated monomer used as a cross-linking component include divinylbenzene, ethylene glycol di(meth)acrylate, diethylene glycol di(meth)acrylate, triethylene glycol di(meth)acrylate, polyethylene glycol di(meth)acrylate, 1,3-butanediol di(meth)acrylate, 1,4-butanediol di(meth)acrylate, 1,6-butanediol di(meth)acrylate, neopentyl glycol dimethacrylate, trimethylolpropane triethoxy tri(meth)acrylate, trimethylolpropane tri(meth)acrylate, pentaerythritol tri(meth)acrylate, pentaerythritol tetra(meth)acrylate, dipentaerythritol hexa(meth)acrylate, and allyl methacrylate.

[Method for Polymerizing Polymerizable Unsaturated Monomer (E)]

In the present invention, in the case of polymerizing the polymerizable unsaturated monomer (E) in the presence of the polymer-treated pigment (D), the polymerizable unsaturated monomer (E) may be polymerized by a well-known or common method unless effects of the present invention are impaired. The polymerizable unsaturated monomer (E) is usually polymerized in the presence of a polymerization initiator. Examples of the polymerization initiator include radical-generating polymerization catalysts such as azobisisobutyronitrile (AIBN), 2,2-azobis(2-methylbutyronitrile), benzoyl peroxide, t-butyl perbenzoate, t-butyl-2-ethylhexanoate, t-butyl hydroperoxide, di-t-butyl peroxide, and cumene hydroperoxide. The catalysts are used alone or in combination.

[Treatment with a Plurality of Types of Polyvalent Metal Salts]

In the present invention, the pigment composition can be prepared through a step of synthesizing the azo dye by coupling the coupler component with the diazo component obtained by diazotizing the aromatic amine, a step of preparing the polymer-treated pigment (D) containing the azo lake pigment (A) and the aqueous polymer (C) precipitated with the polyvalent metal salt (b-1) in such a way that the aqueous polymer (C) precipitated with the polyvalent metal salt (B) is added to the azo dye and the azo dye and the aqueous polymer (C) precipitated with the polyvalent metal salt (b-1) are co-precipitated with a polyvalent metal salt (b-1), a step of producing the polymer (F) by polymerizing the polymerizable unsaturated monomer (E) in the presence of the polymer-treated pigment (D) to coat the polymer-treated pigment (D) with the polymer (F), and a step of partially or entirely replacing the polyvalent metal salt (b-1) in the polymer-treated pigment (D) with a polyvalent metal salt (b-2) different from the polyvalent metal salt (b-1) by subjecting the polyvalent metal salt (b-2) to reaction. This allows the performance of the polyvalent metal salt (b-1) to be exhibited during lacing and also allows a new function to be imparted by replacing the polyvalent metal salt (b-1) with the polyvalent metal salt (b-2).

For example, a metal salt used to produce the azo lake pigment is often a calcium salt. This is because a calcium-laced azo pigment has the following features: good bleed resistance, stable viscosity, high coloring strength, and good dispersibility. However, in the case of using the azo lake pigment for aqueous inks, there is a problem in that the calcium salt in the azo lake pigment is eluted in an aqueous medium to cause a change in hue.

Therefore, calcium present on the outside of the polymer-treated pigment (D) is replaced with strontium in such a way that the polymer (F) is produced by subjecting the polymerizable unsaturated monomer (E) to reaction in the presence of the polymer-treated pigment (D) laced with the calcium salt and is allowed to react with a strontium salt, whereby the coloring strength and hue of the calcium salt in a central portion thereof are maintained and the outside thereof is increased in water resistance with the strontium salt. Hence, the excellent pigment composition can be obtained.

This is an example. Various polyvalent metal salts may be used in combination depending on applications. A laced metal may be entirely or partially replaced.

In the case of subjecting the polyvalent metal salt (b-2) to reaction, after the surface of the polymer-treated pigment (D) laced with the polyvalent metal salt (b-1) is coated with the polymer (F) by the polymerization of the polymerizable unsaturated monomer (E), the metal salt may be replaced continuously in the same reaction vessel by adding the polyvalent metal salt (b-2) to a pigment-mixed solution. Alternatively, after the polymerizable unsaturated monomer (E) is polymerized, the metal salt may be replaced in such a way that a mixed solution containing a polymer-coated pigment is filtered, obtained slurry is suspended in water or is dried, is crushed, and is then suspended in water, and the polyvalent metal salt (b-2) is added.

[Aqueous Inkjet Ink]

The pigment composition according to the present invention can be used as a pigment composition suitable for use in aqueous inkjet inks. An aqueous inkjet ink containing the pigment composition according to the present invention can be used in thermal and piezoelectric inkjet printers.

The aqueous inkjet ink is an aqueous ink which usually contains water and also contains a pigment and binder resin finely dispersed therein. The aqueous inkjet ink can be produce by dispersing the pigment composition according to the present invention and a binder resin in water.

The binder resin used is not particularly limited and may be a general-purpose ink vehicle. The general-purpose ink vehicle is preferably an aqueous resin. Preferred examples of the aqueous resin include polyvinyl alcohols; polyvinylpyrrolidones; (meth)acrylic resins such as (meth)acrylic acid-(meth)acrylate copolymers; styrene-acrylic resins such as styrene-acrylic acid copolymers, styrene-methacrylic acid copolymers, styrene-methacrylic acid-acrylic acid copolymers, styrene-α-methylstyrene-acrylic acid copolymers, and styrene-α-methylstyrene-acrylic acid-acrylate copolymers; styrene-maleic acid copolymers; styrene-maleic anhydride copolymers; vinylnaphthalene-acrylic acid copolymers; carboxyl group-containing urethane resins; and slats of the aqueous resin.

Examples of a compound for forming salts of the above copolymers include salts of diethylamine, ammonia, ethylamine, triethylamine, propylamine, isopropylamine, dipropylamine, butylamine, isobutylamine, triethanolamine, diethanolamine, aminomethylpropanol, and morpholine. The amount of the compound used to form each of these salts is preferably not less than the neutralization equivalent of a corresponding one of the copolymers.

These aqueous resins may be used alone or in combination. The aqueous resin used herein is not particularly limited in form and may be a random copolymer, a block copolymer, or the like.

In particular, in the case of use in thermal ink jet printers, the weight-average molecular weight (hereinafter simply referred to as Mw) of the binder resin preferably range from 6,000 to 20,000 in order to suppress Kogation in heater sections and in order to obtain an aqueous ink having excellent ejection stability. When the Mw thereof is 6,000 or less, the aqueous ink may possibly have reduced dispersion stability. In contrast, when the Mw thereof is more than 20,000, the aqueous ink tends to have increased viscosity and reduced dispersion stability. Furthermore, Kogation in a heater section is serious to and therefore may possibly cause the misfiring of ink droplets from the tip of a nozzle of a thermal ink jet printer.

The amount of the blended ink vehicle is preferably 1 part to 100 parts by mass and more preferably 2 parts to 70 parts by mass per 100 parts by mass of the polymer-bearing pigment. The resin for pigment dispersion preferably has an acid value of 50 mgKOH/g to 300 mgKOH/g.

In particular, in the case of preparing the aqueous inkjet ink, a salt of a styrene-(meth)acrylic acid copolymer or a benzyl methacrylate-(meth)acrylic acid is preferably used because of its preferable dispersion stability and the like. In the case where the aqueous inkjet ink is prepared in such a way that carboxyl group-containing polyurethane is added to an aqueous dispersion prepared by dispersing the pigment in water in advance using the salt of the styrene-(meth)acrylic acid copolymer or the benzyl methacrylate-(meth)acrylic acid, a printed image having excellent ink-ejecting properties and excellent abrasion resistance can be obtained.

[Aqueous Medium]

An aqueous medium used in the present invention may be water alone or a mixed solvent of water and a water-soluble organic solvent compatible with water. Examples of the water-soluble organic solvent include ketones such as acetone, methyl ethyl ketone, methyl butyl ketone, and methyl isobutyl ketone; alcohols such as methanol, ethanol, 2-propanol, 2-methyl-1-propanol, 1-butanol, and 2-methoxyethanol; ethers such as tetrahydrofuran, 1,4-dioxane, and 1,2-dimethoxyethane; and amides such as dimethylformamide and N-methylpyrrolidone. In particular, a compound selected from the group consisting of ketones containing three to six carbon atoms and alcohols containing one to five carbon atoms is preferably used.

A method for obtaining the aqueous inkjet ink according to the present invention is not particularly limited and may be a known method. For example, a pigment dispersion prepared by dispersing the polymer-bearing pigment in water or an aqueous solvent containing water using the liquid vehicle is diluted with a solvent and the diluted pigment dispersion may be used as ink.

[Other Blends]

The aqueous inkjet ink according to the present invention may contain an anti-drying agent, a penetrant, a surfactant, or another additive.

The anti-drying agent has the effect of reducing the drying of an inkjet-recording aqueous ink in an ejection nozzle of an inkjet printer head. In usual, a water-soluble organic solvent with a boiling point not lower than the boiling point of water.

The following compounds can be cited as a water-soluble organic solvent that can be used as the anti-drying agent: polyvalent alcohols such as ethylene glycol, diethylene glycol, polyethylene glycol, and glycerin; pyrrolidones such as N-methyl-2-pyrrolidone and 2-pyrrolidone; amides; dimethyl sulfoxide; imidazolidinone; and the like. When a solvent is water, the amount of the anti-drying agent used is preferably 1 part to 150 parts per 100 parts of water.

The penetrant is used such that the inkjet-recording aqueous ink which is ejected from an ejection nozzle of an inkjet printer head and which is applied to a recording medium is likely to penetrate the recording medium. The use of the penetrant allows an aqueous solvent to quickly penetrate the recording medium, thereby obtaining a record with less image blurring.

Examples of the penetrant used in the present invention include polyvalent alcohols such as ethylene glycol, 1,2,6-hexanetriol, thiodiglycol, hexylene glycol, and diethylene glycol; diols such as pentanediol and hexanediol; glycol ethers such as propylene glycol laurate; polyvalent alcohol lower alkyl ethers such as diethylene glycol ethyl ether and triethylene glycol monoethyl ether; lower alcohols such as ethanol and isopropyl alcohol; glycol ethers such as diethylene glycol-N-butyl ether; and water-soluble organic solvents such as propylene glycol derivatives. These compounds may be used alone or in combination. More preferred permeability can be achieved by the use of two or more types of these compounds in combination in some cases.

The surfactant is not particularly limited and may be selected from well-known or common surfactants such as anionic surfactants including alkylbenzenesulfonates and higher fatty acid salts, nonionic surfactants including polyoxyethylene fatty acid esters, cationic surfactants, and amphoteric surfactants as appropriate. These surfactants may be used alone or in combination.

Examples of the additive include preservatives, fungicides, and chelating agent for preventing nozzle clogging.

[Production Method]

The aqueous inkjet ink according to the present invention can be produced by a well-known or common method.

As a mixer or disperser for dispersing the pigment, the following apparatuses can be used: for example, various well-known or common dispersers such as ultrasonic homogenizers, high-pressure homogenizers, paint shakers, ball mills, roll mills, sand mills, sand grinders, Dyno-Mill, Dispermatt, SC-Mill, and Nanomizer. When coarse particles are present in the inkjet-recording aqueous ink, the coarse particles cause the clogging of ink ejection nozzles of inkjet printers. Therefore, the coarse particles are preferably removed by centrifugation or filtration after dispersing treatment.

### EXAMPLES

The present invention is described below in detail with reference to examples. The present invention is not limited to the examples. In the examples, the terms “part” and “%” refer to “part by weight” and “% by weight”, respectively.

### Reference Example 1

### Synthesis of Aqueous Polymer C-1

Into a SUS vessel equipped with a thermometer, a stirrer, a reflux condenser, a dropping funnel, and a nitrogen gas inlet tube, 200 parts of toluene and 90 parts of IPA were charged, followed by stirring and replacing air in the reaction vessel with nitrogen. After the reaction vessel was heated to 80° C. while the nitrogen atmosphere in the reaction vessel was maintained, a mixed solution of 158 parts of styrene, 43 parts of acrylic acid, and 20 parts of “Perbutyl® O” (an effective component, t-butyl peroxy-2-ethylhexanoate, produced by NOF Corporation) was added dropwise to the reaction vessel from the dropping funnel over 4 hours. After the dropwise addition thereof was finished, reaction was further continued at the same temperature for 15 hours, whereby a toluene/IPA mixed solution of a copolymer C-1 having an acid value of 145 and a weight-average molecular weight of 23,900 was obtained, the solution having a non-volatile content of 42%.

Into an eggplant-shaped flask, 230 parts of the toluene/IPA mixed solution of the copolymer C-1 was charged. After solvents were vacuum-distilled off using a rotary evaporator, 150 parts of MEK was added to the flask, whereby the copolymer C-1 was dissolved therein. To the MEK solution, 50 parts of a 25% aqueous solution of sodium hydroxide and 900 parts of water were added, followed by vacuum-distilling off MEK using a rotary evaporator. Thereafter, water was added thereto such that the non-volatile content was 10%, whereby an aqueous solution of the aqueous polymer C-1 was obtained.

### Reference Example 2

### Synthesis of Aqueous Polymer C-2

Into a SUS vessel equipped with a thermometer, a stirrer, a reflux condenser, a dropping funnel, and a nitrogen gas inlet tube, 1,000 parts of MEK was charged, followed by stirring and replacing air in the reaction vessel with nitrogen. After the reaction vessel was heated to 80° C. while the nitrogen atmosphere in the reaction vessel was maintained, a mixed solution of 450 parts of butyl acrylate, 400 parts of methyl methacrylate, 150 parts of acrylic acid, and 60 parts of “Perbutyl® O” (an effective component, t-butyl peroxy-2-ethylhexanoate, produced by NOF Corporation) was added dropwise to the reaction vessel from the dropping funnel over 4 hours. After the dropwise addition thereof was finished, reaction was further continued at the same temperature for 15 hours, whereby a MEK solution of a copolymer C-2 having an acid value of 98 and a weight-average molecular weight of 26,300 was obtained, the solution having a non-volatile content of 50%.

Into a separable flask equipped with a stirrer and a dropping funnel, 200 parts of the MEK solution of the copolymer C-2 was charged. To the MEK solution, 35 parts of a 25% aqueous solution of sodium hydroxide was added while the MEK solution was stirred, followed by the dropwise addition of 900 parts of water thereto, whereby a MEK/water solution of the copolymer C-2 was obtained. Thereafter, MEK was vacuum-distilled off using a rotary evaporator and water was added thereto such that the non-volatile content was 10%, whereby an aqueous solution of the aqueous polymer C-2 was obtained.

### Reference Example 3

### Preparation of Aqueous Polymer C-3

Ten parts of a styrene-maleic anhydride copolymer (SMA-3000, produced by Sartomer Company) was charged into an eggplant-shaped flask and was then dissolved in 10 parts of MEK. To the MEK solution, 10 parts of a 25% aqueous solution of sodium hydroxide and 90 parts of water were added, followed by vacuum-distilling off MEK using a rotary evaporator. Thereafter, water was added thereto such that the non-volatile content was 10%, whereby an aqueous solution of an aqueous polymer C-3 which was a styrene-sodium maleate copolymer was obtained.

### Example 1

### Synthesis of Polymer-Treated Pigment D-1

After 34.8 parts of 4-aminotoluene-3-sulfonic acid was dispersed in 50 parts of water, 22.2 parts of 35% hydrochloric acid was added to the dispersion and 32.5 parts of a 40% aqueous solution of sodium nitrite was added to the dispersion at one stroke while the dispersion was maintained at 0° C. by adding ice and water to the dispersion, whereby 650 parts of a suspension containing a diazo component was obtained. Next, after 35.9 parts of 3-hydroxy-2-naphthoic acid was dispersed in 400 parts of 50° C. water, 69 parts of a 25% aqueous solution of caustic sodium was added to and dissolved in the dispersion, followed by the addition of ice and water, whereby 980 parts of a 10° C. aqueous solution containing a coupler component was obtained. The whole suspension containing the diazo component was added to the aqueous solution containing the coupler component at one stroke while the aqueous solution containing the coupler component was stirred. The reaction temperature was maintained at 10° C. to 15° C. After 10 minutes, the completion of a coupling reaction was confirmed by an H-acid color test below. Ninety parts of the aqueous polymer C-1, which was the styrene-sodium acrylate copolymer adjusted to 10%, was added thereto, followed by stirring for 60 minutes and adjustment to a pH of 12.5, whereby an azo dye suspension was obtained. To the azo dye suspension, 40 parts of a 35% aqueous solution of calcium chloride was added, followed by stirring for 60 minutes, whereby a lake-forming reaction was completed. Furthermore, ageing was performed at 80° C. for 90 minutes by heating and stirring. After filtration and water washing were performed, the solid content was adjusted to 27% by pressure filtration, whereby a wet cake of a polymer-treated pigment D-1 containing C. I. Pigment Red 57:1 was obtained.

(H-Acid Color Test) A dilute sodium hydroxide aqueous solution containing 1-amino-8-naphthol-3,5-disulfonic acid (H-acid) was used as a color reagent (coloring reagent). The point of time when no color was visible in a reaction with a coupling reaction solution was taken as the completion of a coupling reaction.

(Preparation of Pigment Composition 1)

Into a wide-mouth polyethylene jar, 56 parts of the wet cake of the polymer-treated pigment D-1, 60 parts of heptane, and 120 parts of 1.25 mm zirconia beads were put, followed by mixing for 90 minutes using a paint shaker (Toyo Seiki Co., Ltd.). After the mixture was diluted with 30 parts of heptane, the zirconia beads were removed, whereby a pigment-mixed solution was prepared. After the pigment-mixed solution was charged into a separable flask equipped with a thermometer, a stirrer, a reflux condenser, and a nitrogen gas inlet tube, a solution prepared by dissolving 0.2 parts of 2,2′-azobis(2-methylbutyronitrile) in 1.4 parts of divinylbenzene (a purity of 55%, DVB-570 produced by Nippon Steel Chemical Co., Ltd.) was added to the flask. After stirring was performed at room temperature for 30 minutes, heating to 80° C. was performed. After reaction was continued at the same temperature for 17 h, a pigment-mixed solution thereby obtained was filtered, followed by drying and crushing, whereby a pigment composition 1 was obtained.

### Example 2

A polymer-treated pigment D-2 laced with strontium was synthesized in substantially the same way as that used in Example 1 except that 112 parts of a 30% aqueous solution of strontium chloride was added to an azo dye suspension instead of the 35% calcium chloride aqueous solution used in the synthesis of the polymer-treated pigment D-1 such that lake was formed. Divinylbenzene was polymerized with respect to the obtained D-2 in the same way as that used in Example 1, whereby a pigment composition 2 was obtained.

### Example 3

In Example 1, after the polymerization of divinylbenzene was carried out at 80° C. for 17 h, a solution prepared by dissolving 10 parts of strontium chloride monohydrate in 100 parts of water was added to the reaction mixture, followed by heating to 80° C. again and then stirring for 1 hour, whereby a calcium salt was partially replaced with a strontium salt. An obtained pigment-mixed solution was filtered, followed by water washing, drying, and crushing, whereby a pigment composition 3 in which one of polyvalent metals contained therein was strontium was obtained.

### Example 4

A pigment composition 4 was obtained in substantially the same way as that used in Example 3 except that 2.8 parts of divinylbenzene used in Example 3 was changed to 0.4 parts of 2,2′-azobis(2-methylbutyronitrile).

### Example 5

A pigment composition 5 was obtained in substantially the same way as that used in Example 3 except that 4.2 parts of divinylbenzene used in Example 3 was changed to 0.8 parts of 2,2′-azobis(2-methylbutyronitrile).

### Example 6

A pigment composition 6 was obtained in substantially the same way as that used in Example 3 except that 0.56 parts of dicyclopentanyl acrylate (FA-513AS, produced by Hitachi Chemical Co., Ltd.) and 0.84 parts of dicyclopentanyl diacrylate were used instead of divinylbenzene used in Example 3.

### Example 7

A pigment composition 7 was obtained in substantially the same way as that used in Example 3 except that 90 parts of an aqueous solution of the aqueous polymer C-2 was used instead of the aqueous polymer C-1.

### Example 8

A pigment composition 8 was obtained in substantially the same way as that used in Example 7 except that 135 parts of the aqueous solution of the aqueous polymer C-2 was used.

### Example 9

A pigment composition 9 was obtained in substantially the same way as that used in Example 3 except that 90 parts of an aqueous solution of the aqueous polymer C-3 was used instead of the aqueous polymer C-1.

### Comparative Example 1

After 34.8 parts of 4-aminotoluene-3-sulfonic acid was dispersed in 50 parts of water, 22.2 parts of 35% hydrochloric acid was added to the dispersion and 32.5 parts of a 40% aqueous solution of sodium nitrite was added to the dispersion at one stroke while the dispersion was maintained at 0° C. by adding ice and water to the dispersion, whereby 650 parts of a suspension containing a diazo component was obtained. Next, after 35.9 parts of 3-hydroxy-2-naphthoic acid was dispersed in 400 parts of 50° C. water, 69 parts of a 25% aqueous solution of caustic sodium was added to and dissolved in the dispersion, followed by the addition of ice and water, whereby 980 parts of a 10° C. aqueous solution containing a coupler component was obtained. The whole suspension containing the diazo component was added to the aqueous solution containing the coupler component at one stroke while the aqueous solution containing the coupler component was stirred. The reaction temperature was maintained at 10° C. to 15° C. After 10 minutes, the completion of a coupling reaction was confirmed by the above H-acid color test. Ninety parts of a 10% aqueous solution of disproportionated sodium rosinate was added thereto, followed by stirring for 60 minutes and adjustment to a pH of 12.5, whereby an azo dye suspension was obtained. To the azo dye suspension, 40 parts of a 35% aqueous solution of calcium chloride was added, followed by stirring for 60 minutes, whereby a lake-forming reaction was completed. Furthermore, ageing was performed at 80° C. for 90 minutes by heating and stirring. A pigment-mixed solution thereby obtained was filtered, followed by water washing, drying, and crushing whereby a powdery rosin-treated pigment D-3 containing C. I. Pigment Red 57:1 was obtained.

### Comparative Example 2

A step of obtaining a wet cake of the polymer-treated pigment D-1 and steps prior thereto were performed by the same procedure as that used in Example 1 and it was dried, whereby the powdery polymer-treated pigment D-1 was obtained.

### Comparative Example 3

A step of performing ageing at 80° C. in the synthesis of the polymer-treated pigment D-1 and steps prior thereto were performed by the same procedure as that used in Example 1. A solution prepared by dissolving 10 parts of strontium chloride monohydrate in 100 parts of water was added to a water-mixed solution of an obtained pigment, followed by stirring at 80° C. for 1 hour, whereby a calcium salt was partially replaced with a strontium salt. A pigment-mixed solution thereby obtained was filtered, followed by water washing, drying, and crushing, whereby a polymer-treated pigment D-4 in which one of polyvalent metals contained therein was strontium was obtained.

### Comparative Example 4

One part of powder obtained by drying the styrene-acrylic acid copolymer C-1 synthesized in Reference Example 1 was added to 10 parts of the powdery polymer-treated pigment D-1 obtained in Comparative Example 2, whereby a pigment composition was obtained.

### Reference Example 5

### Synthesis of Acrylic Polymer (Ac)

Into a SUS vessel equipped with a thermometer, a stirrer, a reflux condenser, a dropping funnel, and a nitrogen gas inlet tube, 100 parts of MEK was charged, followed by stirring and replacing air in the reaction vessel with nitrogen. After the reaction vessel was heated to 80° C. while the nitrogen atmosphere in the reaction vessel was maintained, a mixture containing 87.8 parts of benzyl methacrylate, 12.2 parts of methacrylic acid and 6 parts of “Perbutyl® O” (an effective component, t-butyl peroxy-2-ethylhexanoate, produced by NOF Corporation) was added dropwise to the reaction vessel from the dropping funnel over 2 hours. After the dropwise addition thereof was finished, 0.5 parts of “Perbutyl® O” was added every 4 hours and reaction was continued at 80° C. for 12 hours. In this way, a MEK solution of a copolymer (Ac) having an acid value of 80 and a weight-average molecular weight of 25,000 was obtained, the solution having a non-volatile content of 50%.

### Example 10

### Production of Aqueous Pigment Dispersion

Into a 100 mL polymer jar, 2.4 parts of the acrylic copolymer (Ac) obtained in Reference Example 5, 1.92 parts of a 5% aqueous solution of potassium hydroxide, 4 parts of the pigment composition 1 obtained in Example 1, 0.8 parts of MEK, 10.88 parts of ion-exchanged water, and zirconia beads with a diameter of 0.5 mm were charged, followed by mixing. The mixture was dispersed for 2 hours using a paint conditioner. After dispersion was finished, MEK was distilled off from a liquid obtained by removing the zirconia beads using an evaporator, coarse particles were removed by centrifugation (6,000 G for 30 minutes). Thereafter, the non-volatile content was adjusted to 20% by adding water to the liquid, whereby an aqueous pigment dispersion 1 was obtained.

(Measurement of Pigment Particle Size of Aqueous Pigment Dispersions)

After the pigment dispersion was 1,000 times diluted by adding ion-exchanged water thereto, the cumulant average particle size was measured using a fiber-optics particle analyzer, FPAR 1000, (manufactured by Otsuka Electronics Co., Ltd.).

A: a particle size of less than 200 nm.

B: a particle size of 200 nm to less than 250 nm.

C: a particle size of 250 nm or more.

(Measurement of Viscosity of Aqueous Pigment Dispersions)

The pigment dispersion was measured at 25° C. under a condition of 6 rpm using a Brookfield viscometer, DV−II+Pro.

A: a viscosity of less than 5 mPa·s.

B: a viscosity of 5 mPa·s to less than 10 mPa·s.

C: a viscosity of 10 mPa·s or more.

(Storage Stability of Aqueous Pigment Dispersions)

After the aqueous pigment dispersion was left stationary at 70° C. for 7 days, the pigment particle size and viscosity thereof were measured using the particle analyzer and the viscometer.

One having a rate of change in particle size of 10% or less and a rate of change in viscosity of 50% or less was rated as “A”, one having a rate of change in particle size of 20% or less and a rate of change in viscosity of 100% or less was rated as “B”, and one having rates exceeding these ranges was rated as “C” on the basis of an initial measurement.

(Preparation of Aqueous Inkjet Ink)

Twenty five parts of the aqueous pigment dispersion 1 obtained as described above, 10 parts of diethylene glycol monobutyl ether, 15 parts of diethylene glycol, 0.8 parts of SURFYNOL 465 (produced by Air Products, Inc.), and 49.2 parts of ion-exchanged water were blended, followed by filtration with a filter having a pore size of 8 μm, whereby an inkjet-recording aqueous ink 1 was prepared.

The inkjet-recording aqueous ink 1 prepared as described above was evaluated for print density and glossiness in such a way that printing was performed using a piezoelectric inkjet printer (PX-G930 type, manufactured by Seiko Epson Corporation). A recording medium used was inkjet paper (“Photo Paper Gloss” produced by Seiko Epson Corporation). Results are shown in Tables 1 and 2.

(Measurement of Print Density)

A solid image was printed on a sheet of inkjet paper. Three points of each sample were measured for color image density using a densitometer (GRETAG® D196 manufactured by GretagMacbeth) and the average of the measurements was taken as the print density. A larger value represents better print density.

(Measurement of Hue)

A solid image was printed on a sheet of inkjet paper. Three points of each sample were measured for b* value using a densitometer (GRETAG® D196 manufactured by GretagMacbeth) and the measurements were averaged. A larger b* value represents a more yellowish hue.

(Measurement of Glossiness of Image)

Color images were printed on sheets of inkjet paper at a duty of 60%, 80%, or 100% (solid). The glossiness of the color images was measured at a measurement angle of 20 degrees using a haze glossmeter (manufactured by BYK Gardner) as a glossmeter. Three points of each sample were measured and the average of the measurements was taken as the glossiness. The sum of gloss values is shown in the tables as gloss. A larger value represents better gloss.

### Examples 11 to 18

Pigment dispersions 2 to 9 and aqueous inkjet inks 2 to 9 were prepared in substantially the same way as that used in Example 10 except that the pigment composition was changed to those shown in Table 1 or 2, followed by similar evaluation.

### Comparative Examples 5 to 8

Comparative pigment dispersions 1 to 4 and comparative aqueous inkjet inks 1 to 4 were prepared in substantially the same way as that used in Example 10 except that the pigment composition was changed to those shown in Table 3, followed by similar evaluation. Incidentally, the symbol “−” shown in the columns of OD value, b* value, and gloss in Table 2 means that evaluation was impossible because printing was impossible.

As a result, the aqueous pigment dispersions obtained in Examples 11 to 13 and 15 to 18 had excellent storage stability because the rate of change with respect to the measured initial particle size was 10% or less and the rate of change with respect to the initial viscosity was 50% or less. In contrast, Comparative Example 5, in which existing disproportionated rosin treatment was performed, exhibited high viscosity and poor storage stability. In addition, Comparative Examples 6, 7, and 8, in which a polymer coating step due to the reaction of a polymerizable unsaturated monomer was not performed, exhibited a large particle size, high viscosity, and poor storage stability. In particular, Comparative Example 8, in which an aqueous polymer was added to an aqueous polymer-treated pigment later, exhibited poorer storage stability as compared to Comparative Example 6, in which no aqueous polymer was added.

In addition, the aqueous inkjet inks of Examples 10 to 18 were excellent in printing suitability. In particular, Examples 12, 15, 16, and 18, in which the treatment amount of an aqueous polymer was 25% and the amount of a polymerizable unsaturated monomer used was about 10%, exhibited extremely high print density and gloss. In contrast, the inkjet recording inks of Comparative Examples 5, 6, and 8 were incapable of printing anything and therefore were incapable of being evaluated for print density or gloss.

TABLE 1

| | | Example 10 | Example 11 | Example 12 | Example 13 | Example 14 |
|---|---|---|---|---|---|---|
| Pigment name | | Pigment | Pigment | Pigment | Pigment | Pigment |
| | | composition 1 | composition 2 | composition 3 | composition 4 | composition 5 |
| Aqueous polymer (C) name | | C-1 | C-1 | C-1 | C-1 | C-1 |
| Each value in parentheses is the | | (25) | (25) | (25) | (25) | (25) |
| treatment amount (%) with respect to | | | | | | |
| PR-57:1. | | | | | | |
| Polymerizable | DVB570 | 12 | 12 | 12 | 24 | 36 |
| unsaturated monomer | FA513AS | | | | | |
| (E) name and the | DCPA | | | | | |
| treatment amount (%) | | | | | | |
| with respect to PR-57:1 | | | | | | |
| Polyvalent metal salt | | Ca | Sr | Ca/Sr | Ca/Sr | Ca/Sr |
| Evaluation results of | Dispersion | A | A | A | B | A |
| pigment dispersion | particle size | | | | | |
| | Dispersion | B | A | A | A | A |
| | viscosity | | | | | |
| | Storage | B | A | A | A | B |
| | stability | | | | | |
| Evaluation results | Printing | A | A | A | A | A |
| of print | suitability | | | | | |
| | OD value | 1.7 | 1.9 | 2.0 | 1.5 | 1.5 |
| | (max) | | | | | |
| | b* | 33 | 57 | 35 | 26 | 27 |
| | Gloss | 22 | 25 | 140 | 3 | 3 |

TABLE 2

| | | Example 15 | Example 16 | Example 17 | Example 18 |
|---|---|---|---|---|---|
| | | Pigment | Pigment | Pigment | Pigment |
| Pigment name | | composition 6 | composition 7 | composition 8 | composition 9 |
| Aqueous polymer (C) name | | C-1 | C-2 | C-2 | C-3 |
| Each value in parentheses is the treatment | | (25) | (25) | (43) | (25) |
| amount (%) with respect to PR-57:1. | | | | | |
| Polymerizable unsaturated | DVB570 | | 10 | 10 | 10 |
| monomer (E) name and the | FA513AS | 4.8 | | | |
| treatment amount (%) with | DCPA | 7.2 | | | |
| respect to PR-57:1 | | | | | |
| Polyvalent metal salt | | Ca/Sr | Ca/Sr | Ca/Sr | Ca/Sr |
| Evaluation results of pigment | Dispersion | A | A | A | A |
| dispersion | particle size | | | | |
| | Dispersion | A | A | A | A |
| | viscosity | | | | |
| | Storage | A | A | A | A |
| | stability | | | | |
| Evaluation results of print | Printing | A | A | A | A |
| | suitability | | | | |
| | OD value | 1.9 | 2.0 | 2.0 | 2.0 |
| | (max) | | | | |
| | b* | 36 | 32 | 27 | 37 |
| | Gloss | 109 | 112 | 96 | 173 |

TABLE 3

| | | Comparative | Comparative | Comparative | Comparative |
|---|---|---|---|---|---|
| | | Example 5 | Example 6 | Example 7 | Example 8 |
| | | Comparative | Comparative | Comparative | Comparative |
| Pigment name | | Example 1 | Example 2 | Example 3 | Example 4 |
| Aqueous polymer (C) name | | Disproportionated | C-1 | C-1 | C-1 |
| Each value in parentheses is the treatment | | rosin | (25) | (43) | (25) |
| amount (%) with respect to PR-57:1. | | (25) | | | |
| Added polymer name | | | | | C-1 |
| Each value in parentheses is the treatment | | | | | (12) |
| amount (%) with respect to PR-57:1. | | | | | |
| Polyvalent metal salt | | Ca | Ca | Ca/Sr | Ca |
| Evaluation results of | Dispersion | A | A | B | B |
| pigment dispersion | particle size | | | | |
| | Dispersion | B | C | B | C |
| | viscosity | | | | |
| | Storage | C | C | C | C |
| | stability | | | | |
| Evaluation results | Printing | C | C | A | C |
| of print | suitability | | | | |
| | OD value | — | — | 1.8 | — |
| | (max) | | | | |
| | b* | — | — | 32 | — |
| | Gloss | — | — | 106 | — |

### INDUSTRIAL APPLICABILITY

A pigment composition according to the present invention can be preferably used as a colorant for ink, paint, and resin. The pigment composition is particularly excellent in dispersion stability and storage stability in aqueous media and therefore can be preferably used as an aqueous ink composition, particularly an aqueous inkjet ink.

1. A pigment composition containing:
a polymer-treated pigment (D) containing an azo lake pigment (A) and an aqueous polymer (C) precipitated with a polyvalent metal salt (B); and
a polymer (F) obtained by polymerizing a polymerizable unsaturated monomer (E) in the presence of the polymer-treated pigment (D).

2. The pigment composition according to claim 1, wherein the polyvalent metal salt (B) is a calcium salt or a strontium salt.

3. A method for producing a pigment composition, comprising:
a step of synthesizing an azo dye by coupling a coupler component with a diazo component obtained by diazotizing an aromatic amine;
a step of preparing a polymer-treated pigment (D) containing an azo lake pigment (A) and an aqueous polymer (C) precipitated with a polyvalent metal salt (B) in such a way that the aqueous polymer (C) precipitated with the polyvalent metal salt (B) is added to the azo dye and the azo dye and the aqueous polymer (C) precipitated with the polyvalent metal salt (B) are co-precipitated with the polyvalent metal salt (B); and
a step of producing a polymer (F) by polymerizing a polymerizable unsaturated monomer (E) in the presence of the polymer-treated pigment (D) to coat the polymer-treated pigment (D) with the polymer (F).

4. A method for producing a pigment composition, comprising:
a step of synthesizing an azo dye by coupling a coupler component with a diazo component obtained by diazotizing an aromatic amine;
a step of preparing a polymer-treated pigment (D) containing an azo lake pigment (A) and an aqueous polymer (C) precipitated with a polyvalent metal salt (B) in such a way that the aqueous polymer (C) precipitated with the polyvalent metal salt (B) is added to the azo dye and the azo dye and the aqueous polymer (C) precipitated with the polyvalent metal salt (B) are co-precipitated with a polyvalent metal salt (b-1);
a step of producing a polymer (F) by polymerizing a polymerizable unsaturated monomer (E) in the presence of the polymer-treated pigment (D) to coat the polymer-treated pigment (D) with the polymer (F); and
a step of partially or entirely replacing the polyvalent metal salt (b-1) in the polymer-treated pigment (D) with a polyvalent metal salt (b-2) different from the polyvalent metal salt (b-1) by subjecting the polyvalent metal salt (b-2) to reaction.

5. A pigment composition obtained by the method according to claim 3.

6. An aqueous inkjet ink containing the pigment composition according to claim 1.

7. A pigment composition obtained by the method according to claim 4.

8. An aqueous inkjet ink containing the pigment composition according to claim 2.

9. An aqueous inkjet ink containing the pigment composition according to claim 5.
